(19) United States
(12) Patent Application Publication
(10) Pub. No.: US 2026/0160309 A1
(43) Pub. Date: Jun. 11, 2026

(54) POCKET TUBE AND SHOCK ABSORBER INCLUDING THE SAME

(71) Applicant: HL Mando Corporation, Pyeongtaek-si (KR)

(72) Inventors: Jeonggil KIM, Pyeongtaek-si (KR); Minhwa SONG, Pyeongtaek-si (KR); Kwangduk BAEK, Pyeongtaek-si (KR)

(21) Appl. No.: 19/412,103

(22) Filed: Dec. 8, 2025

(30) Foreign Application Priority Data
Dec. 9, 2024 (KR) 10-2024-0181759
Sep. 9, 2025 (KR) 10-2025-0128441

(51) Int. Cl. F16F 9/02; B60G 13/10

(52) U.S. Cl. CPC F16F 9/0218; B60G 13/10

(57) ABSTRACT

A pocket tube and a shock absorber including the same are disclosed. The pocket tube is disposed in an interior of a shock absorber filled with a damping fluid and includes: a first tube body configured to have a first outer diameter; a second tube body configured to have a second outer diameter smaller than the first outer diameter, the second tube body being coaxially connected to one axial end of the first tube body and extending therefrom; and at least one through-hole configured to penetrate both an inner circumferential surface and an outer circumferential surface of the second tube body.

### CROSS-REFERENCE TO RELATED APPLICATION

This application claims priority to and benefit from Korean Patent Applications No. 10-2024-0181759, filed on Dec. 9, 2024, No. 10-2025-0128441, filed on Sep. 9, 2025, the disclosure of which is incorporated herein by reference in their entirety.

### BACKGROUND

### Technical Field

The present disclosure relates to a shock absorber, and more particularly, to a pocket tube disposed in a shock absorber that is installed in a vehicle to mitigate impact applied to a vehicle body during driving of the vehicle, and to a shock absorber including the same.

### Related Art

A shock absorber is installed in a vehicle to suppress vibrations transmitted to a vehicle body during driving of the vehicle, thereby improving ride comfort. In addition, the shock absorber suppresses rapid vibrations of vehicle wheels during driving of the vehicle, thereby enhancing driving stability.

In the shock absorber, a pressure tube is divided into a rebound chamber (upper chamber) and a compression chamber (lower chamber) by a piston valve. In some shock absorbers, to improve damping performance generated during a rebound stroke, a pocket tube that forms an additional chamber in the rebound chamber is disposed, and a hydraulic stopper ring that enters the pocket tube during the rebound stroke is employed.

In this regard, there is a need for improving tunability of damping characteristics using the pocket tube, enhancing assemblability of the pocket tube, and reducing manufacturing costs of the pocket tube.

### SUMMARY

It is an object of the present disclosure to provide a pocket tube and a shock absorber including the same, which have improved tunability of damping performance.

It is another object of the present disclosure to provide a pocket tube and a shock absorber including the same, which have enhanced assemblability.

It is still another object of the present disclosure to provide a pocket tube and a shock absorber including the same, which can reduce manufacturing costs.

The objects of the present disclosure are not limited to the above-described objects, and other objects that are not mentioned will be able to be clearly understood by those skilled in the art to which the present disclosure pertains from the following description.

According to an aspect of the present disclosure, a pocket tube disposed in an interior of a shock absorber filled with a damping fluid is provided, the pocket tube including: a first tube body configured to have a first outer diameter; a second tube body configured to have a second outer diameter smaller than the first outer diameter, the second tube body being coaxially connected to one axial end of the first tube body and extending therefrom; and at least one through-hole configured to penetrate both an inner circumferential surface and an outer circumferential surface of the second tube body.

In a pocket tube according to an aspect of the present disclosure, a plurality of through-holes may be disposed on the second tube body at intervals along the axial direction.

In a pocket tube according to an aspect of the present disclosure, the first tube body and the second tube body may have the same inner diameter.

In a pocket tube according to an aspect of the present disclosure, an outer circumferential inclined portion may be provided on an outer circumferential surface of an end of the second tube body adjacent to the first tube body, the outer circumferential inclined portion having an outer diameter that increases toward the one axial end of the first tube body.

In a pocket tube according to an aspect of the present disclosure, an inner circumferential inclined portion may be provided at an axial end of the second tube body opposite to the first tube body, the inner circumferential inclined portion having an inner diameter increasing away from the first tube body.

In a pocket tube according to an aspect of the present disclosure, a cut may be formed at an axial end of the second tube body opposite to the first tube body, the cut being recessed by partially removing the second tube body toward the first tube body.

In a pocket tube according to an aspect of the present disclosure, a plurality of cuts may be disposed on the outer circumferential surface of the second tube body at regular intervals along a circumferential direction.

In a pocket tube according to an aspect of the present disclosure, a flange may be provided at an axial end of the first tube body opposite to the second tube body, the flange protruding radially outward from an outer circumferential surface of the first tube body.

According to another aspect of the present disclosure, a shock absorber is provided, including: a pressure tube configured to define a chamber that extends vertically and is filled with a working fluid; a rod configured to extend into an interior of the pressure tube; a piston coupled to the rod and disposed in the chamber to divide the chamber into a lower chamber and an upper chamber; a hydraulic stopper ring coupled to an outer circumferential surface of the rod above the piston; and a pocket tube disposed in the upper chamber such that the hydraulic stopper ring enters the pocket tube during a rebound stroke in which the piston moves toward the upper chamber, wherein the pocket tube may include a first tube body configured to have a first outer diameter; a second tube body configured to have a second outer diameter smaller than the first outer diameter, the second tube body being coaxially connected to one axial end of the first tube body and extending therefrom; and at least one through-hole configured to penetrate both an inner circumferential surface and an outer circumferential surface of the second tube body.

In a shock absorber according to an aspect of the present disclosure, the first outer diameter may correspond to an inner diameter of the pressure tube.

In a shock absorber according to an aspect of the present disclosure, the pocket tube may be disposed such that the first tube body is positioned at an upper end side of the pressure tube, and a flange may be provided at an axial end of the first tube body opposite to the second tube body, the flange protruding radially outward from an outer circumferential surface of the first tube body to engage the upper end of the pressure tube and fix the pocket tube.

In a shock absorber according to an aspect of the present disclosure, an annular flow channel may be formed between an outer circumferential surface of the second tube body and an inner circumferential surface of the pressure tube.

In a shock absorber according to an aspect of the present disclosure, a plurality of through-holes may be disposed on the second tube body at intervals along the axial direction.

In a shock absorber according to an aspect of the present disclosure, the first tube body and the second tube body may have the same inner diameter.

In a shock absorber according to an aspect of the present disclosure, an outer circumferential inclined portion may be provided on an outer circumferential surface of an end of the second tube body adjacent to the first tube body, the outer circumferential inclined portion having an outer diameter that increases toward the one axial end of the first tube body.

In a shock absorber according to an aspect of the present disclosure, an inner circumferential inclined portion may be provided at an axial end of the second tube body opposite to the first tube body, the inner circumferential inclined portion having an inner diameter increasing away from the first tube body.

In a shock absorber according to an aspect of the present disclosure, a cut may be formed at an axial end of the second tube body opposite to the first tube body, the cut being recessed by partially removing the second tube body toward the first tube body.

In a shock absorber according to an aspect of the present disclosure, a plurality of cuts may be disposed on the outer circumferential surface of the second tube body at regular intervals along a circumferential direction.

In a shock absorber according to an aspect of the present disclosure, the shock absorber may further include a pressure tube cover including: an annular cover body disposed to cover an upper end of the pressure tube and penetrated by the rod; and a cover sleeve configured to have an outer diameter corresponding to an inner diameter of the pocket tube, the cover sleeve extending from the cover body into the interior of the pocket tube and penetrated by the rod.

In a shock absorber according to an aspect of the present disclosure, a tapered portion may be provided at an end of the cover sleeve disposed inside the pocket tube, the tapered portion being formed such that the outer diameter of the cover sleeve gradually decreases.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a cutaway perspective view of a shock absorber according to an embodiment of the present disclosure.

FIG. 2 is a perspective view of a pocket tube according to an embodiment of the present disclosure.

FIG. 3 is a longitudinal cross-sectional view of the pocket tube according to an embodiment of the present disclosure.

FIG. 4 is a longitudinal cross-sectional perspective view of the pocket tube according to an embodiment of the present disclosure.

FIG. 5 is a view illustrating a flow channel and operation of a shock absorber according to an embodiment of the present disclosure.

FIG. 6 is a view illustrating a manufacturing process of a pocket tube according to an embodiment of the present disclosure.

### DETAILED DESCRIPTION OF EXEMPLARY EMBODIMENTS

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their disclosure.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

In the following description, directional terms such as “upper,” “lower,” “left,” and “right” are used for convenience of explanation with reference to the drawings, and are not intended to limit the present disclosure to any particular orientation.

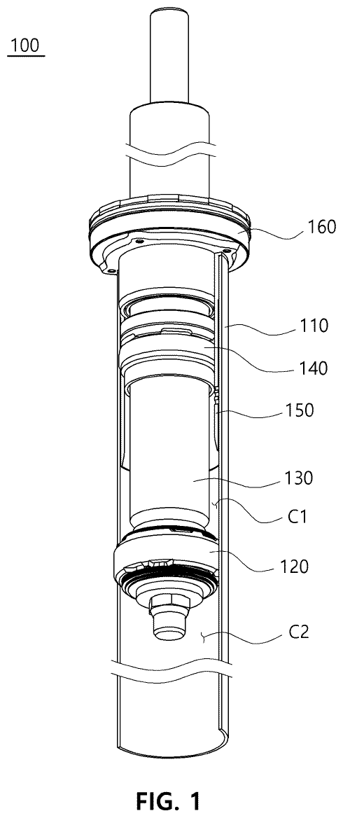

FIG. 1 is a perspective sectional view of a shock absorber according to an embodiment of the present disclosure.

Referring to FIG. 1, a shock absorber 100 according to an embodiment of the present disclosure includes a pocket tube 150 according to an embodiment of the present disclosure.

The shock absorber 100 according to an embodiment of the present disclosure is installed in a vehicle and is capable of absorbing shocks transmitted from a road surface to the vehicle. More specifically, the shock absorber 100 is installed between a chassis and a vehicle body so as to mitigate shocks applied from the road surface to the vehicle body. In addition, the shock absorber 100 provides additional damping force during a rebound stroke through the pocket tube 150.

Referring to FIG. 1, a shock absorber 100 according to an embodiment of the present disclosure includes a pressure tube 110, a piston 120, a rod 130, a hydraulic stopper ring 140, a pocket tube 150, and a pressure tube cover 160.

The pressure tube 110 is configured to define a chamber that extends vertically and is filled with a working fluid. In the interior of the pressure tube 110, damping is performed through a compression stroke or a rebound stroke of the piston 120 and the rod 130. The chamber defined inside the pressure tube 110 is divided into an upper chamber C1 positioned above the piston 120 and a lower chamber C2 positioned below the piston 120.

Meanwhile, although not shown, an outer tube may be disposed surrounding the pressure tube 110. The outer tube may have an inner diameter larger than an outer diameter of the pressure tube 110 and may be disposed concentrically with the pressure tube 110.

A reservoir may be formed in a space between the outer tube and the pressure tube 110. The reservoir may be filled with the working fluid. In addition to the working fluid, a gas may also be charged into the reservoir. The reservoir may communicate with the upper chamber C1 or the lower chamber C2 of the pressure tube 110.

The piston 120 divides the chamber defined inside the pressure tube 110 into the upper chamber C1 and the lower chamber C2. That is, the interior of the pressure tube 110 may be divided into the upper chamber C1 located above the piston 120 and the lower chamber C2 located below the piston 120.

The piston 120 may reciprocate up and down together with the rod 130 inside the pressure tube 110. If the piston 120 descends, that is, during the compression stroke of the piston 120, the working fluid disposed in the lower chamber C2 may flow to the upper chamber C1 through a compression passage formed inside the piston 120. If the piston 120 ascends, that is, during a rebound stroke of the piston 120, the working fluid disposed in the upper chamber C1 may flow to the lower chamber C2 through a rebound passage formed inside the piston 120.

In this regard, the piston 120 may be provided with a plurality of valve members configured to open or close the compression passage or the rebound passage according to a pressure difference between the upper chamber C1 and the lower chamber C2. A damping force may be generated according to the flow of the working fluid that occurs during the compression stroke or the rebound stroke.

The rod 130 is configured to extend into an interior of the pressure tube 110. More specifically, the rod 130 enters from an upper side of the pressure tube 110 and extends into the interior of the pressure tube 110. An upper end of the rod 130 extends upward beyond the pressure tube 110 and may be fixed to the vehicle body or the chassis, and a lower end of the rod 130 is positioned inside the pressure tube 110.

A piston 120 is connected to a lower side of the rod 130, and the rod 130 may be disposed to penetrate the piston 120.

If the rod 130 moves downward, the piston 120 descends inside the pressure tube 110 to perform the compression stroke. If the rod 130 moves upward, the piston 120 ascends inside the pressure tube 110 to perform the rebound stroke.

The hydraulic stopper ring 140 is coupled to an outer circumferential surface of the rod 130 above the piston 120. The hydraulic stopper ring 140 may have an outer diameter corresponding to an inner diameter of the pocket tube 150.

During the rebound stroke of the shock absorber 100, the hydraulic stopper ring 140 enters the interior of the pocket tube 150 and ascends. As the hydraulic stopper ring 140 ascends within the pocket tube 150, the working fluid disposed inside the pocket tube 150 flows from the inside of the pocket tube 150 to the outside of the pocket tube 150. Through such a flow of the working fluid from the inside to the outside of the pocket tube 150, an additional damping force is generated.

The hydraulic stopper ring 140 may be configured to block the working fluid located above the hydraulic stopper ring 140 from flowing to the lower side of the hydraulic stopper ring 140 while the hydraulic stopper ring 140 has entered inside the pocket tube 150 during the rebound stroke.

In addition, the hydraulic stopper ring 140 may be provided with a suction passage configured to allow the working fluid to flow from the upper chamber C1 into the interior of the pocket tube 150. The suction passage serves to equalize a pressure difference generated above and below the hydraulic stopper ring 140 inside the pocket tube 150 if the hydraulic stopper ring 140 moves downward within the pocket tube 150 during the compression stroke.

The pocket tube 150 is disposed in the upper chamber C1 so that the hydraulic stopper ring 140 enters the interior of the pocket tube 150 during the rebound stroke in which the piston 120 moves toward the upper chamber C1. The pocket tube 150 forms a chamber that generates an additional damping force during the rebound stroke inside the upper chamber C1.

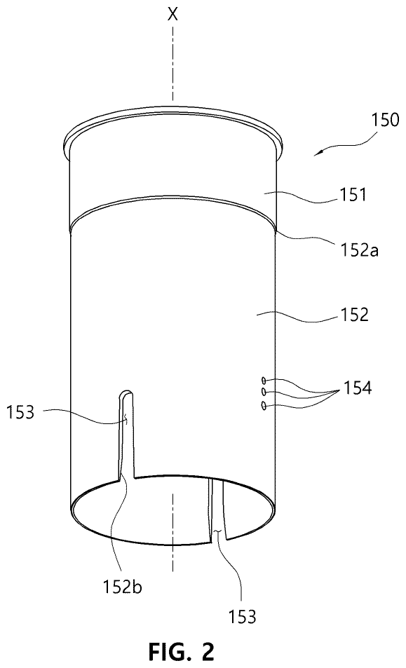

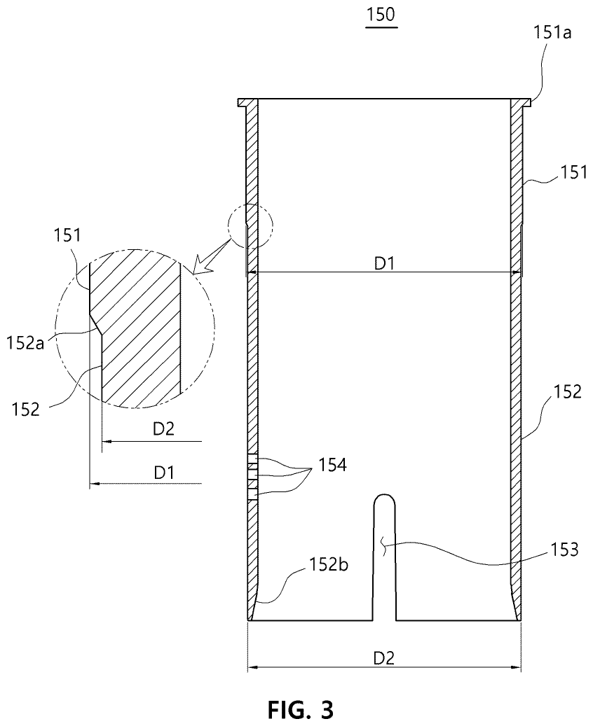

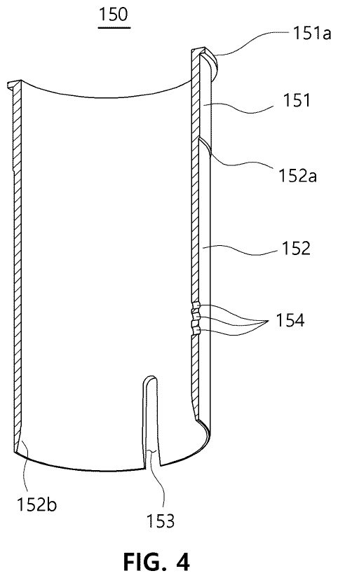

FIG. 2 is a perspective view of a pocket tube according to an embodiment of the present disclosure. FIG. 3 is a longitudinal cross-sectional view of the pocket tube according to an embodiment of the present disclosure. FIG. 4 is a longitudinal cross-sectional perspective view of the pocket tube according to an embodiment of the present disclosure.

Referring to FIGS. 2 to 4, the pocket tube 150 includes a first tube body 151, a second tube body 152, and through-hole 154.

The first tube body 151 has a first outer diameter D1. The first tube body 151 may be disposed to be surrounded by the pressure tube 110 of the shock absorber 100.

The first tube body 151 may be disposed coaxially with the pressure tube 110. In addition, the first outer diameter D1 may correspond to an inner diameter of the pressure tube 110. That is, the first tube body 151 may be fitted into the pressure tube 110.

The second tube body 152 has a second outer diameter D2 smaller than the first outer diameter D1, and is connected coaxially to one axial end of the first tube body 151 and extends therefrom. The second tube body 152 may be integrally formed with the first tube body 151.

The first tube body 151 and the second tube body 152 may have the same inner diameter. The first tube body 151 and the second tube body 152 may form a flow path having the same inner diameter.

The first tube body 151 is disposed above the second tube body 152 inside the pressure tube 110. The pocket tube 150 is inserted into the interior of the pressure tube 110 through an upper end of the pressure tube 110, and the second tube body 152 enters the interior of the pressure tube 110 before the first tube body 151.

As described above, the first outer diameter D1 corresponds to an inner diameter of the pressure tube 110, and the second outer diameter D2 is smaller than the first outer diameter D1. Therefore, the second tube body 152 can be smoothly inserted into the interior of the pressure tube 110, and subsequently, alignment and fixation of the first tube body 151 inserted into the pressure tube 110 can be efficiently achieved.

In addition, an outer circumferential inclined portion 152a may be provided on an outer circumferential surface of an end of the second tube body 152 adjacent to the first tube body 151, the outer circumferential inclined portion 152a having an outer diameter that increases toward one axial end of the first tube body 151. The outer circumferential inclined portion 152a enables smooth insertion of the first tube body 151 into the pressure tube 110 after insertion of the second tube body 152 when the pocket tube 150 enters the interior of the pressure tube 110.

The first tube body 151 is positioned at an upper end side of the pressure tube 110. In this regard, a flange 151a is provided at an axial end of the first tube body 151 opposite to the second tube body 152, the flange 151a protruding radially outward from an outer circumferential surface of the first tube body 151 to engage the upper end of the pressure tube 110 and fix the pocket tube 150.

Due to the flange 151a, the pocket tube 150 may be caught by and fixed to an upper end of the pressure tube 110. That is, the flange 151a allows the pocket tube 150 to stably maintain a predetermined position inside the pressure tube 110.

Meanwhile, a cut 153 may be formed at an axial end of the second tube body 152 opposite to the first tube body 151, the cut 153 being recessed by partially removing a portion of the second tube body 152 toward the first tube body 151. The cut 153 may have an inverted U-shape or an inverted V-shape.

A plurality of cuts 153 may be provided on an outer circumferential surface of the second tube body 152 at regular intervals along a circumferential direction. In an embodiment of the present disclosure, two cuts 153 are disposed 180 degrees apart along the circumferential direction of the second tube body 152.

During the rebound stroke of the shock absorber 100, the hydraulic stopper ring 140 enters the interior of the pocket tube 150 through an axial end distal end of the second tube body 152 opposite to the first tube body 151, that is, a lower end of the second tube body 152. The cut 153 provides flexibility and elasticity to the lower end of the second tube body 152, thereby mitigating an impact applied to the pocket tube 150 when the hydraulic stopper ring 140 enters the pocket tube 150 and facilitating smooth entry of the hydraulic stopper ring 140 into the interior of the pocket tube 150.

In addition, the hydraulic stopper ring 140 may be displaced in a rebound or compression direction, that is, vertically, as well as laterally, depending on an installation orientation of the shock absorber 100 and a direction of an impact applied to a vehicle equipped with the shock absorber 100. If the hydraulic stopper ring 140 is displaced laterally and strikes an inner wall of the pocket tube 150, the cut 153 allows the second tube body 152 to deform, thereby dispersing or absorbing the impact. Accordingly, the durability of the pocket tube 150 can be improved.

In addition, an inner circumferential inclined portion 152b may be provided at an axial end of the second tube body 152 opposite to the first tube body 151, the inner circumferential inclined portion 152b having an inner diameter that increases away from the first tube body 151. As described above, the outer diameter of the hydraulic stopper ring 140 may correspond to the inner diameter of the pocket tube 150. Therefore, in order for the hydraulic stopper ring 140 to smoothly enter the pocket tube 150, precise alignment between the hydraulic stopper ring 140 and the pocket tube 150 is required. The inner circumferential inclined portion 152b allows a certain level of tolerance in the alignment between the hydraulic stopper ring 140 and the pocket tube 150. That is, the inner circumferential inclined portion 152b enables smooth entry of the hydraulic stopper ring 140 into the interior of the pocket tube 150.

The through-hole 154 is disposed to penetrate both an inner circumferential surface and an outer circumferential surface of the second tube body 152. A plurality of through-holes 154 may be provided, that is, two or more may be arranged. A plurality of through-holes 154 may be disposed on the second tube body 152 at intervals along an axis X. For example, three through-holes 154 may be arranged at regular intervals along the axial direction.

A plurality of through-holes 154 may also be disposed at regular intervals along a circumferential direction as well as along an axial direction of the second tube body 152. For example, the through-holes 154 may be arranged 180 degrees apart along the circumferential direction of the second tube body 152.

At this time, the through-holes 154 may be alternately arranged with the cuts 153 at regular intervals along the circumferential direction of the second tube body 152. That is, the through-holes 154 and the cuts 153 may be alternately arranged at 90-degree intervals along the circumferential direction of the second tube body 152.

In an embodiment of the present disclosure, three through-holes 154 are arranged at regular intervals along the axial direction to form one set, and two such sets are arranged 180 degrees apart along the circumferential direction of the second tube body 152.

During the rebound stroke of the shock absorber 100, the through-hole 154 provides a passage through which a fluid, which is pressurized upward by the hydraulic stopper ring 140 when the hydraulic stopper ring 140 enters the interior of the pocket tube 150, flows from the inside of the pocket tube 150 to the outside of the pocket tube 150.

The damping force generated when the hydraulic stopper ring 140 enters the interior of the pocket tube 150 may vary depending on the number, position, and size of the through-holes 154. For example, as the size of the through-hole 154 decreases, a fluid resistance applied to the working fluid passing through the through-hole 154 increases, and accordingly, the damping force increases.

In an embodiment of the present disclosure, the plurality of through-holes 154 may decrease in size from a lower side toward an upper side. If the upper through-holes 154 are configured to be smaller than the lower through-holes 154, fluid resistance generated as the working fluid pressurized by the hydraulic stopper ring 140 passes through the through-holes 154 increases as the hydraulic stopper ring 140 ascends within the pocket tube 150 during the rebound stroke. Accordingly, the damping force gradually increases as the hydraulic stopper ring 140 moves upward, thereby mitigating an impact generated at a maximum rebound stroke.

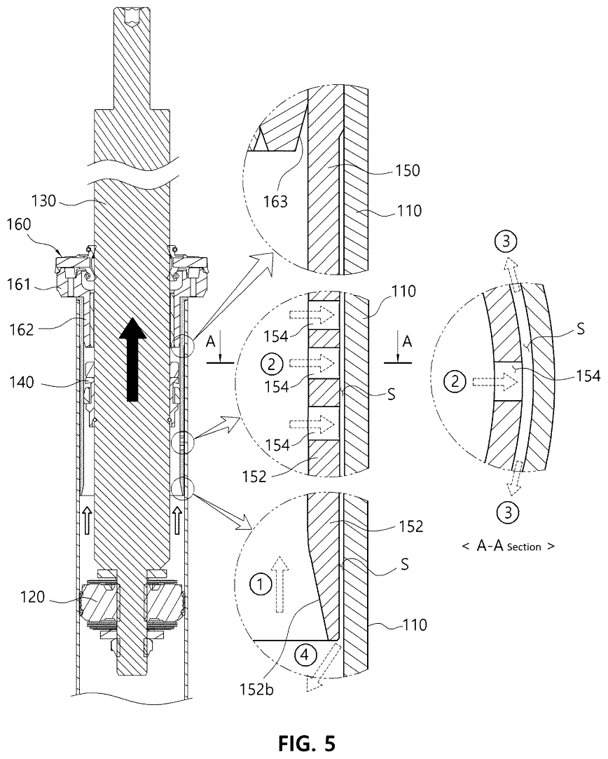

FIG. 5 is a view illustrating a flow channel and operation of a shock absorber according to an embodiment of the present disclosure.

Referring to FIG. 5, an annular flow channel S is formed between an outer circumferential surface of the second tube body 152 and an inner circumferential surface of the pressure tube 110.

The through-holes 154 of the pocket tube 150 need to be disposed at locations that allow the interior of the pocket tube 150 to communicate with the flow channel S. Since the annular flow channel S is formed between an outer circumferential surface of the second tube body 152 and an inner circumferential surface of the pressure tube 110, enabling the through-holes 154 to be disposed at any position along the circumferential direction of the second tube body 152.

Accordingly, a degree of freedom in forming an inflow passage from the interior of the pocket tube 150 to the annular flow channel S is increased. This leads to improved tunability of damping performance of the shock absorber 100.

During the rebound stroke of the shock absorber 100, the piston 120, the rod 130, and the hydraulic stopper ring 140 moves upward inside the pressure tube 110. Accordingly, a portion of the working fluid disposed in the upper chamber C1 moves to the lower chamber C2 through the piston 120.

In addition, when the hydraulic stopper ring 140 enters and ascends inside the pocket tube 150 (\textcircled{1}), the working fluid disposed inside the pocket tube 150 passes through the through-holes 154(\textcircled{2}) and flows out into the flow channel S (\textcircled{3}). The working fluid discharged into the flow channel S then moves toward a lower end of the pocket tube 150 (\textcircled{4}). Through this process, an additional damping force is generated during the rebound stroke.

Referring to FIGS. 1 and 5, the shock absorber 100 may further include a pressure tube cover 160. The pressure tube cover 160 covers upper ends of the pressure tube 110 and the pocket tube 150 in a form that allows the rod 130 to reciprocate vertically.

The shock absorber 100 includes a pressure tube cover 160 including an annular cover body 161 disposed to cover an upper end of the pressure tube 110 and penetrated by the rod 130, and a cover sleeve 162 having an outer diameter corresponding to an inner diameter of the pocket tube 150, the cover sleeve 162 extending from the cover body 161 into the interior of the pocket tube 150 and penetrated by the rod 130. The cover body 161 and the cover sleeve 162 may be integrally formed.

The pressure tube cover 160 not only covers an upper end of the pressure tube 110 but also serves to guide movement of the rod 130. In addition, the cover sleeve 162 presses an inner circumferential surface of the pocket tube 150 radially outward, thereby enhancing stability of coupling between the pocket tube 150 and the pressure tube 110.

Meanwhile, a tapered portion 163 may be provided at an end of the cover sleeve 162 disposed inside the pocket tube 150, the tapered portion 163 being formed such that an outer diameter of the cover sleeve 162 gradually decreases. More specifically, the tapered portion 163 may be formed such that the outer diameter of the cover sleeve 162 is reduced toward a lower end of the cover sleeve 162.

If the rod 130 moves up and down, the cover sleeve 162 may strike an inner circumferential surface of the pocket tube 150. The tapered portion 163 provides a space that serves as a buffer between the cover sleeve 162 and the pocket tube 150.

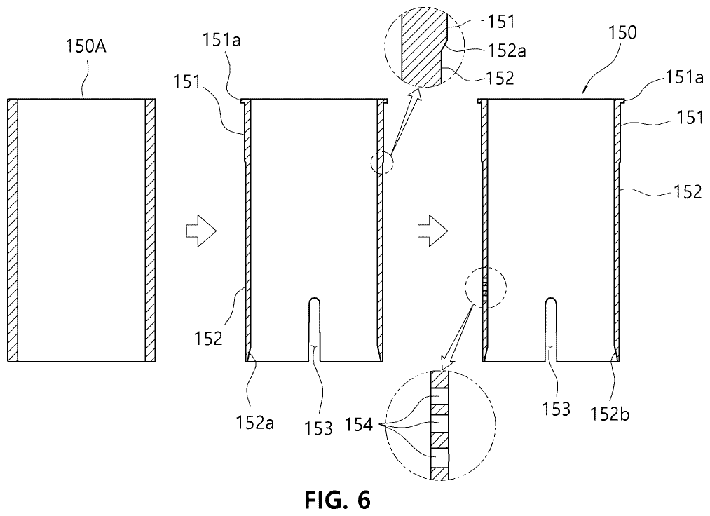

FIG. 6 is a view illustrating a manufacturing process of a pocket tube according to an embodiment of the present disclosure.

Referring to FIG. 6, the pocket tube 150 may be manufactured from a single tubular member 150A having a first outer diameter. The single tubular member 150A having the first outer diameter may be obtained through a drawing process.

In addition, an outer circumferential surface of a lower portion of the tubular member 150A is machined so as to have a second outer diameter smaller than the first outer diameter. Through such machining, the tubular member 150A has a first tube body 151 at an upper portion having the first outer diameter and a second tube body 152 connected to a lower side of the first tube body 151 and having the second outer diameter smaller than the first outer diameter.

For example, the second tube body 152 may be formed by turning the outer circumferential surface of the lower portion of the tubular member 150A. In addition, machining is performed such that an outer circumferential inclined portion 152a is formed at an axial end of the second tube body 152 adjacent to the first tube body 151, and an inner circumferential inclined portion 152b and a cut 153 are formed at a lower end of the second tube body 152.

As described above, at least one through-hole 154 is formed in the second tube body 152. The damping force generated when the hydraulic stopper ring 140 enters the interior of the pocket tube 150 may vary depending on the number, position, and size of the through-holes 154. In this regard, since the second tube body 152 forms an annular flow channel S with the pressure tube 110, a degree of freedom in setting parameters such as the number and position of the through-holes 154 is increased, and tunability of the shock absorber 100 can be improved.

According to the above configuration, the pocket tube and the shock absorber including the same according to the present disclosure provide a high degree of freedom in forming an inflow passage from the interior of the pocket tube to the annular channel by forming the annular channel between the pocket tube and the pressure tube, thereby increasing tunability of damping performance.

The pocket tube according to the present disclosure can be smoothly inserted into an interior of the pressure tube of the shock absorber, thereby improving assemblability of the shock absorber.

In addition, the pocket tube and the shock absorber including the same according to the present disclosure do not require a milling process during manufacture of the pocket tube, and thus manufacturing cost can be reduced.

It should be understood that the effects of the present disclosure are not limited to the above-described effects, and include all effects inferable from a configuration of the invention described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. A pocket tube disposed in an interior of a shock absorber filled with a damping fluid, comprising:
a first tube body configured to have a first outer diameter;
a second tube body configured to have a second outer diameter smaller than the first outer diameter, the second tube body being coaxially connected to one axial end of the first tube body and extending therefrom; and
at least one through-hole configured to penetrate both an inner circumferential surface and an outer circumferential surface of the second tube body.

2. The pocket tube of claim 1, wherein a plurality of through-holes are disposed on the second tube body at intervals along the axial direction.

3. The pocket tube of claim 1, wherein the first tube body and the second tube body have the same inner diameter.

4. The pocket tube of claim 1, wherein an outer circumferential inclined portion is provided on an outer circumferential surface of an end of the second tube body adjacent to the first tube body, the outer circumferential inclined portion having an outer diameter that increases toward the one axial end of the first tube body.

5. The pocket tube of claim 1, wherein an inner circumferential inclined portion is provided at an axial end of the second tube body opposite to the first tube body, the inner circumferential inclined portion having an inner diameter increasing away from the first tube body.

6. The pocket tube of claim 1, wherein a cut is formed at an axial end of the second tube body opposite to the first tube body, the cut being recessed by partially removing the second tube body toward the first tube body.

7. The pocket tube of claim 6, wherein a plurality of cuts are disposed on the outer circumferential surface of the second tube body at regular intervals along a circumferential direction.

8. The pocket tube of claim 1, wherein a flange is provided at an axial end of the first tube body opposite to the second tube body, the flange protruding radially outward from an outer circumferential surface of the first tube body.

9. A shock absorber comprising:
a pressure tube configured to define a chamber that extends vertically and is filled with a working fluid;
a rod configured to extend into an interior of the pressure tube;
a piston coupled to the rod and disposed in the chamber to divide the chamber into a lower chamber and an upper chamber;
a hydraulic stopper ring coupled to an outer circumferential surface of the rod above the piston; and
a pocket tube disposed in the upper chamber such that the hydraulic stopper ring enters the pocket tube during a rebound stroke in which the piston moves toward the upper chamber,
wherein the pocket tube comprises:
a first tube body configured to have a first outer diameter;
a second tube body configured to have a second outer diameter smaller than the first outer diameter, the second tube body being coaxially connected to one axial end of the first tube body and extending therefrom; and
at least one through-hole configured to penetrate both an inner circumferential surface and an outer circumferential surface of the second tube body.

10. The shock absorber of claim 9, wherein the first outer diameter corresponds to an inner diameter of the pressure tube.

11. The shock absorber of claim 10, wherein the pocket tube is disposed such that the first tube body is positioned at an upper end side of the pressure tube, and
a flange is provided at an axial end of the first tube body opposite to the second tube body, the flange protruding radially outward from an outer circumferential surface of the first tube body to engage the upper end of the pressure tube and fix the pocket tube.

12. The shock absorber of claim 9, wherein an annular flow channel is formed between an outer circumferential surface of the second tube body and an inner circumferential surface of the pressure tube.

13. The shock absorber of claim 9, wherein a plurality of through-holes are disposed on the second tube body at intervals along the axial direction.

14. The shock absorber of claim 9, wherein the first tube body and the second tube body have the same inner diameter.

15. The shock absorber of claim 9, wherein an outer circumferential inclined portion is provided on an outer circumferential surface of an end of the second tube body adjacent to the first tube body, the outer circumferential inclined portion having an outer diameter that increases toward the one axial end of the first tube body.

16. The shock absorber of claim 9, wherein an inner circumferential inclined portion is provided at an axial end of the second tube body opposite to the first tube body, the inner circumferential inclined portion having an inner diameter increasing away from the first tube body.

17. The shock absorber of claim 9, wherein a cut is formed at an axial end of the second tube body opposite to the first tube body, the cut being recessed by partially removing the second tube body toward the first tube body.

18. The shock absorber of claim 17, wherein a plurality of cuts are disposed on the outer circumferential surface of the second tube body at regular intervals along a circumferential direction.

19. The shock absorber of claim 9, further comprising:
a pressure tube cover including
an annular cover body disposed to cover an upper end of the pressure tube and penetrated by the rod; and
a cover sleeve configured to have an outer diameter corresponding to an inner diameter of the pocket tube, the cover sleeve extending from the cover body into the interior of the pocket tube and penetrated by the rod.

20. The shock absorber of claim 19, wherein a tapered portion is provided at an end of the cover sleeve disposed inside the pocket tube, the tapered portion being formed such that the outer diameter of the cover sleeve gradually decreases.
